(19) United States
(12) Patent Application Publication
(10) Pub. No.: US 2025/0193771 A1
(43) Pub. Date: Jun. 12, 2025

(54) SERVICE MANAGEMENT IN WIRELESS NETWORKS

(71) Applicant: Lenovo (Singapore) Pte. Limited, Singapore (SG)

(72) Inventors: Sheeba Backia Mary Baskaran, Friedrichsdorf (DE); Andreas Kunz, Ladenburg (DE)

(73) Assignee: Lenovo (Singapore) Pte. Limited, Singapore (SG)

(21) Appl. No.: 18/845,730

(22) PCT Filed: Mar. 10, 2023
(86) PCT No.: PCT/IB2023/052326

§ 371 Date: Sep. 10, 2024

Related U.S. Application Data
(60) Provisional application No. 63/318,726, filed on Mar. 10, 2022.

(51) Int. Cl. H04W 48/02; H04W 8/02; H04W 12/041; H04W 84/04

(52) U.S. Cl. CPC H04W 48/02; H04W 8/02; H04W 12/041; H04W 84/042

(57) ABSTRACT

Various aspects of the present disclosure relate to a UE that is connected to a visited network requests a network service from the visited network. The service request is rejected, and the UE and the visited network communicate rejection reports for the service rejection to the home network of the UE. Further, the home network considers received service rejection information from the UE and/or the visited network to provide configuration of preferred visited network and/or access technology combinations to the UE.

### RELATED APPLICATION

This application claims priority to U.S. Patent Application Ser. No. 63/318,726 filed 10 Mar. 2022 entitled “SERVICE MANAGEMENT IN WIRELESS NETWORKS,” the disclosure of which is incorporated by reference herein in its entirety.

### TECHNICAL FIELD

The present disclosure relates to wireless communications, and more specifically to managing network services in wireless networks.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Some wireless communications systems utilize network configurations that allow multiple network portions (e.g., virtualized and/or independent networks) to be created on top of a physical infrastructure. Each network portion can be characterized as a network slice that can be allocated based on the specific needs of a user, an application, use case, and so forth. Further, networks can provide various services, such as by exposing services via different network slices.

### SUMMARY

The present disclosure relates to methods, apparatuses, and systems that support service management in wireless networks. By utilizing the described techniques, a UE and a visited network (e.g., visited public land mobile network (VPLMN), standalone non-public network (SNPN), visited non-public network (VNPN)) are able to report subscribed network service (e.g., network slice service) status to a home network of the UE, e.g., a home public land mobile network (HPLMN). For instance, when a UE connected to a visited network requests a network service from the visited network and the service request is rejected, the UE and the visited network can communicate rejection reports for the service rejection to the home network of the UE. Further, implementations are described for securely generating rejection reports and communicating the rejection reports to the home network to ensure validity of rejection reports received at the home network. Implementations also enable a home network to consider received slice rejection information from a UE and/or a visited network to take home operator policy specific actions and to provide configuration of preferred visited network and/or access technology combinations to a UE to enable the UE to utilize the preferred visited network and/or access technology combinations to access network services to which the UE is subscribed. Thus, the described techniques increase the reliability and quality of network services provided to UEs.

Some implementations of the method and apparatuses described herein may include wireless communication at a device (e.g., a UE), and the device receives a first message indicating a service rejection for a service associated with a network slice, the first message including service rejection information; generates, based at least in part on the receiving the first message, a second message indicating the service rejection and a reference identifier associated with the service rejection; generates a key to protect the second message; generates a secured second message using the key and the second message; and transmits the secured second message.

Some implementations of the method and apparatuses described herein may include wireless communication at a device (e.g., a base station and/or core network function), and the device receives, at a visited network from a UE, a service request for access to a service associated with a network slice; rejects, based on a condition, the service request; generates a message that includes a UE identifier for the UE, an identifier for the service associated with the network slice, and service rejection information; and transmits the message to a home network of the UE

Some implementations of the method and apparatuses described herein may include wireless communication at a device (e.g., a base station or core network function), and the device receives a secured first message generated by a UE, the secured first message including a UE identifier and indicating that the secured first message is associated with a service rejection; and verifies the secured first message using a key associated with one or more of the UE identifier or the service rejection

Some implementations of the method and apparatuses described herein may include wireless communication at a device (e.g., a network device), and the device receives a key request including one or more of a UE identifier, a reference identifier associated with a secured first message, or a freshness parameter; deriving a key based on the key request; and communicating the key.

Some implementations of the method and apparatuses described herein may include wireless communication at a device (e.g., a network device), and the device receives a key request including one or more of an authentication and key management for applications key identifier (A-KID), an application function identifier, a freshness parameter, a slice service reporting security indication, a slice service reporting security code, or combinations thereof; derives a key based on the key request; and communicates the key

### BRIEF DESCRIPTION OF THE DRAWINGS

Various aspects of the present disclosure for service management in wireless networks are described with reference to the following Figures. The same numbers may be used throughout to reference like features and components shown in the Figures.

FIG. 1 illustrates an example of a wireless communications system that supports service management in wireless networks in accordance with aspects of the present disclosure.

FIG. 2 illustrates an example of a system that supports service management in wireless networks and may use the wireless communications system in accordance with aspects of the present disclosure.

FIG. 3 illustrates an example of a system that supports service management in wireless networks in accordance with aspects of the present disclosure.

FIG. 4 illustrates an example of a block diagram of a device (e.g., a UE) that supports service management in wireless networks in accordance with aspects of the present disclosure.

FIG. 5 illustrates an example of a block diagram of a device (e.g., a base station) that supports service management in wireless networks in accordance with aspects of the present disclosure.

FIG. 6 illustrates an example of a block diagram of a device (e.g., a network device) that supports service management in wireless networks in accordance with aspects of the present disclosure.

FIGS. 7-11 illustrate flowcharts of methods that support service management in wireless networks in accordance with aspects of the present disclosure.

### DETAILED DESCRIPTION

Implementations of service management in wireless networks are described, such as related to enabling a UE and a visited network (e.g., VPLMN, SNPN, VNPN) to report subscribed network service (e.g., network slice service) status to a home network, e.g., HPLMN. For instance, when a UE connected to a visited network requests a network service from the visited network and the service request is rejected, the UE and the visited network can communicate rejection reports for the service rejection to the home network of the UE. Further, implementations are described for securely generating rejection reports and communicating the rejection reports to the home network to ensure validity of rejection reports received at the home network. Implementations also enable a home network to consider received slice rejection information from a UE and/or a visited network to take home operator policy specific actions and to provide configuration of preferred visited network and/or access technology combinations to a UE to enable the UE to utilize the preferred visited network and/or access technology combinations to access network services to which the UE is subscribed.

In some wireless communications systems, as part of registration of roaming UEs with a visited network, a home network can provide subscription data (e.g., along with slice subscription data) of a UE to the visited/serving network (e.g., VPLMN, SNPN, VNPN, etc.) to allow the VPLMN to serve the UE based on subscribed network slices, e.g., single network slice selection assistance information (S-NSSAIs). Further, based on a service level agreement between a home network and a visited network, the visited network can be expected to serve the subscribed slices provided by the home network. However, in some scenarios, if a UE requests in a registration request a set of services (e.g., S-NSSAIs based on the subscribed S-NSSAI, such as the UE's subscribed slices with a home network and/or mobile network operator), a condition may cause the visited network to reject the request. For instance, the visited network such as due to lack of sufficient resources may deny or reject the subscribed slices requested by the UE for registration. Some wireless communications systems do not provide a means for a home network to know if a visited network is serving subscribed slices requested by the UE and/or if a requested subscribed slices are rejected by the visited network. The visited network in this case, for example, informs the UE about the rejected slices but does not send slice rejection information to the home network. Thus, in some wireless communications systems there is no method for a home network in a UE roaming scenario to monitor the UE's subscribed slice serving status from a visited network.

Accordingly, implementations of service monitoring in wireless networks are described, such as related to service monitoring in wireless networks. For instance, a UE associated with a home serving network (e.g., HPLMN) can register to receive services from a visited serving network, e.g., a VPLMN. Further, the services can be provided via network slices of the visited serving network. Accordingly, when the UE requests a service from the visited serving network (e.g., when the UE is in a roaming scenario and is connected to the visited serving network), the UE may receive a service rejection from the visited serving network. For instance, due to a condition at the visited serving network (e.g., insufficient service resources), the visited serving network rejects the request from the UE for provision of a service associated with a network slice and/or the service request fails at the visited serving network resulting in a service request failure.

Based on the rejected service request, implementations provide rejection reporting to enable information about the rejected service request to be shared and stored in a trusted manner. For instance, the UE that experiences the service rejection generates a first rejection report that includes different information about the service rejection and communicates the first rejection report to a home network of the UE. Further, the visited serving network that rejected the service request generates a second rejection report that includes information about the service rejection and communicates the second rejection report to the home network. The home network can perform a verification action based on the first rejection report and the second rejection report, such as to verify the authenticity and/or accuracy of information included in the rejection reports. This provides secure and trusted ways for different functions associated with network services (e.g., a home serving network and/or 3rd party service providers) to obtain information about network services provided by other networks, e.g., visited serving networks. Further, information about network service rejections can be utilized to generate preferred visited network and/or network service information, which enables a UE to be configured to access visited networks that are likely to provide more reliable and/or secure provision of network services to the UE.

Aspects of the present disclosure are described in the context of a wireless communications system. Aspects of the present disclosure are further illustrated and described with reference to device diagrams and flowcharts that relate to service management in wireless networks.

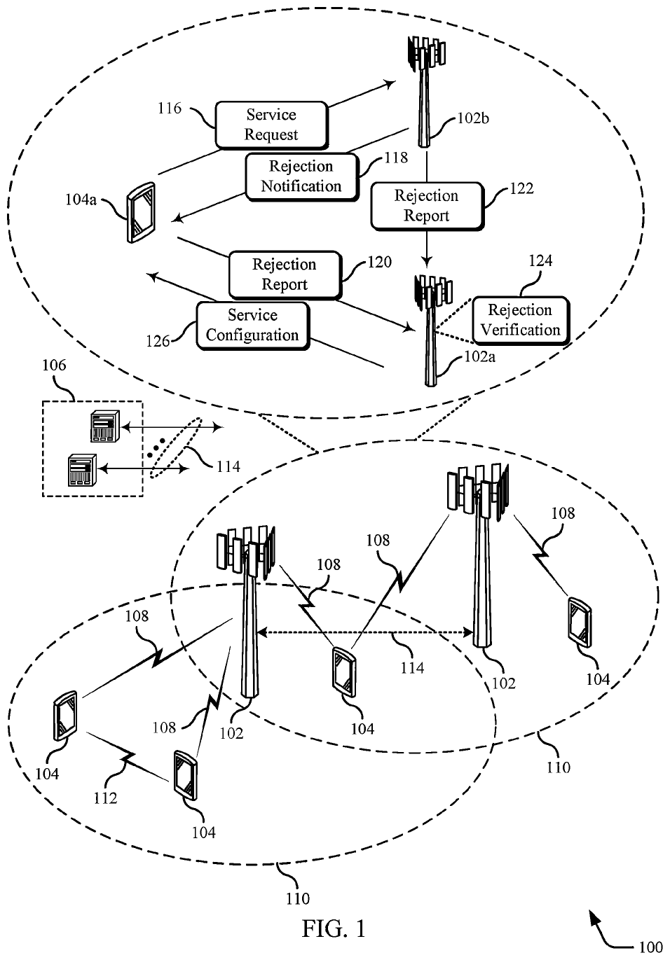

FIG. 1 illustrates an example of a wireless communications system 100 that supports service management in wireless networks in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (LAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a Session Management Function (SMF), a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of service monitoring in wireless networks, as described herein. For instance, consider that a UE 104a is a subscriber to a home network (e.g., a HPLMN) associated with a base station 102a. Further, the UE 104a is connected to a base station 102b of a visited network, e.g., a VPLMN, a standalone non-public network (SNPN), etc., The UE 104a, for instance, is in a roaming scenario and is thus connected to the base station 102b. While the UE 104a is connected to the base station 102b, the UE 104a communicates a service request 116 to the base station 102b. The service request 116, for example, requests that the base station 102b and/or its visited network provide a service or set of services to the UE 104a. The requested service(s), for example, include a service provided by a network slice of the visited network.

In response to the service request 116 the base station 102b communicates a rejection notification 118 indicating that one or more requested services are rejected by the base station 102b. For instance, based on a particular condition, the visited network of the base station 102b rejects the service request 116. The rejection notification 118 can include various information pertaining to the service rejection, such as an identifier for a rejected service, a reason and/or cause of the rejection, a reference identifier for the rejection, and so forth. Further examples of different information that can be included in the rejection notification 118 are detailed below. Based on the rejection notification 118 the UE 104a communicates a rejection report 120 to the base station 102a and/or its associated home network, such as via the connection of the UE 104a to the base station 102b. The rejection report 120 includes various information such as information from the rejection notification 118 as well as other information generated by the UE 104a. Further, the base station 102b communicates a rejection report 122 to the base station 102a and/or the home network associated with the base station 102a. The rejection report 122 includes various information pertaining to the service rejection, such as information populated to the rejection notification 118.

Accordingly, based on the rejection report 120 and/or the rejection report 122, the base station 102a and/or its associated home network perform rejection verification 124, such as to verify the authenticity and/or validity of the information included in the rejection reports 120, 122. Detailed aspects of the rejection verification 124 are presented below and in the accompanying figures. Based at least in part on the rejection verification 124, the base station 102a and/or its associated home network generate service configuration 126 and communicates the service configuration 126 to the UE 104a. The service configuration 126 includes various service-related and/or network-related configuration for the UE 104a, such as preferred visited networks for the UE 104a, such as preferred visited networks for providing network services (e.g., slice services) to the UE 104a. Thus, the UE 104a can receive the service configuration 126 and configure operation of the UE 104a based on the service configuration 126, such as to steer roaming behavior and/or network service-related behavior of the UE 104a.

In some wireless communications systems, as part of registration of roaming UEs with a visited network, a home network can provide subscription data (e.g., along with slice subscription data) of a UE to the visited/serving network (e.g., VPLMN) to allow the VPLMN to serve the UE based on subscribed network slices, e.g., S-NSSAIs. Further, based on a service level agreement between a home network and a visited network, the visited network can be expected to serve the subscribes slices provided by the home network. However, in some scenarios, if a UE requests in a registration request a set of services (e.g., S-NSSAIs based on the subscribed S-NSSAI, such as the UE's subscribed slices with a home network and/or mobile network operator), a condition may cause the visited network to reject the request. For instance, the visited network such as due to lack of sufficient resources may deny or reject the subscribed slices requested by the UE for registration. In some wireless communications systems do not provide a means for a home network to know if a visited network is serving subscribed slices requested by the UE and/or if any requested subscribed slices are rejected by the visited network due to any reason. The visited network in this case, for example, informs the UE about the rejected slices but does not send slice rejection information to the home network. Thus, in some wireless communications systems there is no method for a home network in a UE roaming scenario to monitor the UE's subscribed slice serving status from a visited network.

Further, some wireless systems can provide Steering of Roaming (SoR) information to a UE via an AMF (e.g., a list of preferred PLMN/access technology combinations and/or Credentials Holder controlled prioritized lists of preferred SNPNs and GINs or HPLMN/Credentials Holder indication that ‘no change of the above list(s) stored in the UE is needed’). A home network can include an indication for the UE to send an acknowledgement of the reception of this information.

Further, as part of SOR, If the MS receives a USAT REFRESH command qualifier of type “Steering of Roaming”, the MS can:
a) replace the highest priority entries in the “Operator Controlled PLMN Selector with Access Technology” list stored in the ME with the list provided in the REFRESH command;
b) delete the PLMNs identified by the list in the REFRESH command from the Forbidden PLMN list and from the Forbidden PLMNs for GPRS service list, if they are present in these lists. This includes any information stored in the SIM and the ME internal memory;
c) take the new information into account in subsequent attempts to access a higher priority PLMN; and
d) attempt to obtain service on a higher priority PLMN by acting as if timer T that controls periodic attempts has expired.
In order to avoid unnecessary signaling, the network operator should avoid repeatedly using steering of roaming of a particular MS.’

In SoR over the control plane in a PLMN:
‘The HPLMN updates the “Operator Controlled PLMN Selector with Access Technology” based on the operator policies, which can be based on the registered VPLMN, the location of the UE, etc.’
As the HPLMN needs to consider certain criteria including the number of customers distributed through multiple VPLMNs in the same country or region, the list of the preferred PLMN/access technology combinations is not necessarily the same at all times and for all users. The list of the preferred PLMN/access technology combinations, for instance, is to be dynamically generated, e.g. generated on demand, by a dedicated steering of roaming application function (SOR-AF) providing operator specific data analytics solutions.
The steering of roaming connected mode control information (SOR-CMCI) enables the HPLMN to control the timing of a UE in connected mode to move to idle mode to perform the steering of roaming. The UE can support the SOR-CMCI. The support and use of SOR-CMCI by the HPLMN is based on the HPLMN's operator policy.

Further, if:
the UE's USIM is configured to indicate that the UE can expect to receive the steering of roaming information during initial registration procedure but did not receive it or security check on the steering of roaming information fails;
the current chosen VPLMN is not contained in the list of “PLMNs where registration was aborted due to SOR”;
the current chosen VPLMN is not part of “User Controlled PLMN Selector with Access Technology” list; and
the UE is not in manual mode of operation;
then the UE will perform PLMN selection with the current VPLMN considered as lowest priority.

Further, in some wireless systems, the “Operator Controlled PLMN Selector with Access Technology” list is to be stored in the ME together with the SUPI from the USIM. The ME can delete the “Operator Controlled PLMN Selector with Access Technology” list stored in the ME when a new USIM is inserted.

Thus, in some wireless communications systems there is not only no method for a home network in a UE roaming scenario to monitor the UE's subscribed slice serving status from a visited network, but also a lack of provision for configuring preferred visited networks, e.g., PLMNs, VPLMNs, SNPNs, etc.

Accordingly, aspects of the present disclosure include solutions to enabling a UE and a visited network (e.g., VPLMN, SNPN, VNPN) to report subscribed network service (e.g., network slice service) status to a home network, e.g., HPLMN. For instance, when a UE connected to a visited network requests a network service from the visited network and the service request is rejected, the UE and the visited network can communicate rejection reports for the service rejection to the home network of the UE. Further, implementations are described for securely generating rejection reports and communicating the rejection reports to the home network to ensure validity of rejection reports received at the home network. Implementations also enable a home network to consider received slice rejection information from a UE and/or a visited network to provide configuration of preferred visited network and/or access technology combinations to a UE to enable the UE to utilize the preferred visited network and/or access technology combinations to access network services to which the UE is subscribed.

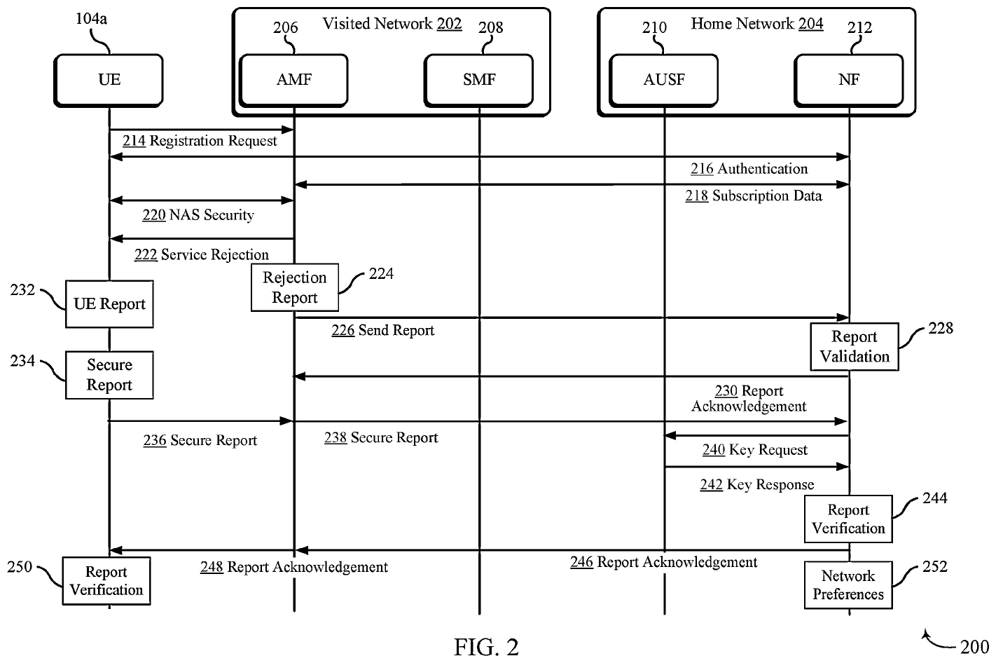

FIG. 2 illustrates an example of a system 200 that supports service management in wireless networks in accordance with aspects of the present disclosure. The system 200 may use the wireless communications system 100 and/or be implemented with the wireless communications system 100. The system 200 includes the UE 104a, a visited network 202, and a home network 204. With reference to the wireless communications system 100, for instance, the base station 102b is associated with (e.g., provides wireless connectivity for) the visited network 202 and the base station 102a is associated with (e.g., provides wireless connectivity for) the home network 204. Further, the home network 204 represents a home network (e.g., HPLMN) of the UE 104a. The visited network 202 includes various functionality for implementing the described techniques, including an AMF 206 and a session management function (SMF) 208. While various operations and communications are discussed herein within the context of the AMF 206 and the SMF 208, it is to be appreciated that a wide variety of network functions may perform the various operations and communications herein, e.g., alternatively or additionally to the AMF 206 and/or the SMF 208.

The home network 204 includes various functionality for implementing the described techniques, including an authentication server function (AUSF) 210 and a network function (NF) 212. The NF 212 can be implemented in a variety of different ways, such as a unified data management (UDM), a unified data repository (UDR), and/or other applicable NF. While various operations and communications are discussed herein within the context of the AUSF 210 and the NF 212, it is to be appreciated that a wide variety of network functions may perform the various operations and communications herein, e.g., alternatively or additionally to the AUSF 210 and/or the NF 212.

In the system 200, the UE 104a is subscribed with its home network 204 to a set of network services and the UE 104a is roaming where it is connected to the visited network 202. The visited network 202, for instance, represents a VPLMN or an SNPN for the UE 104a. At 214 the UE 104a transmits a registration request to the AMF 206 requesting a set of network services (e.g., one or more network services) from the visited network 202. The home network 204, for instance, has a service level agreement to provide network services to roaming UEs that are subscribers of the home network 204. In at least some implementations the registration request at 214 represents a protocol data unit (PDU) session establishment request and/or PDU session modification request to the visited network 202, e.g., a NF of the visited network 202 such as the AMF 206 and/or the SMF 208.

At 216 visited network performs authentication (e.g., primary authentication) of the UE 104a with the home network 204, part of which includes fetching subscription data 218 for the UE 104a such as from the NF 212. The subscription data at 218, for instance, includes subscribed services, slice subscription data, subscribed and/or default NSSAIs/S-NSSAIs, and so forth, of the UE 104a. As part of the authentication at 216, at 220 NAS security can be established.

A condition occurs that causes the visited network 202 to reject at least some requested services. Various conditions may cause service rejection, such as a lack of resources, service usage overload, intent of the visited network 202, etc. At 222 the visited network 202 communicates a service rejection to the UE 104a indicating that at least some requested services are rejected. The service rejection at 222 may be implemented in various ways, such as an indication of registration acceptance with the visited network 202, an indication of registration rejection with the visited network 202, an indication of PDU session establishment between the visited network 202 and the UE 104a, a rejection of PDU session establishment between the visited network 202 and the UE 104a, and so forth. Further, the service rejection at 222 identifies one or more rejected services and optionally, one or more other allowed services for the UE 104a.

The service rejection at 222 may include different information including rejected NSSAIs/S-NSSAIs, a nonce, a random number, a counter, a freshness parameter such as for slice service rejection report tracking reference identifier generation, a cause and/or reason for the service rejection, a serving network identifier, etc. Alternatively or additionally the UE 104a may know an identifier for the visited network 202.

In an implementation, to enable secured service rejection reporting, the visited network 202 may send a reference identifier (e.g., instead of a freshness parameter) to trigger both the UE 104a and the visited network 202 to report service rejection to the home network 204 and/or a 3rd party service provider, e.g., via the home network 204. In an implementation if the visited network 202 does not provide a reference identifier, the UE 104a can provide a reference identifier to the visited network 202 in an acknowledgement message based on the service rejection at 222.

At 224 the visited network 202 generates a rejection report which can include various information such as a report reference identifier, UE ID for the UE 104a (e.g., subscription permanent identifier (SUPI)), subscribed slice identification related to a service (e.g., S-NSSAIs), a service rejection code, a service rejection reason, an identifier and/or name for the visited network 202 (e.g., service network identifier (SN ID) (e.g., for the visited network 202), serving network name (SNN) (e.g., for the visited network 202)), a network function identifier (NF ID), a timestamp and digital signature of the rejection report 224. In implementations the rejection report 224 can be signed by a NF of the visited network 202 using its private key by generating the hash of the rejection report 224 and encrypting it with the private key. A public key and related SN ID/NF ID of the visited network 202 for a slice reporting service can be available with the home network 204 to enable validation of the rejection report 224. In implementations a reference identifier for the rejection report 224 can be generated as: Hash (UE ID, SN ID, NF ID, freshness parameter such as random number, nonce, and/or counter), where the freshness parameter may be assigned by a NF in the visited network 202.

At 226 the visited network 202 sends the rejection report 224 to the home network 204, such as based on a local configuration of the visited network 202, e.g., using a reporting internet protocol (IP) address and/or a fully qualified domain name (FQDN) for the home network 204. In at least one implementation the visited network 202 sends the rejection report 224 using an Nudm_serving operation message and/or a new Nnf_service rejection network report notification service operation message specific to a receiving NF in the home network 204. The rejection report 224 can include various information such as a reference identifier, UE ID (e.g., SUPI), subscribed slice identification related to a service (S-NSSAIs), service rejection code, service rejection reason, identifier and/or name for the visited network 202 (e.g., SN ID, SNN), NF ID, time stamp, digital signature, and combinations thereof.

The NF 212 of the home network 204 performs report validation 228 on the rejection report 224 and stores the validated rejection report. The NF 212, for instance, receives the rejection report 224 and can validate the signature of the report using a public key available for network identifier (e.g., SN ID, SNN) and/or NF ID indicated in the rejection report 224 and on a successful validation can store the rejection report 224. The validated rejection report 224, for instance, can be stored at the home network 204 in the UDM, UDR, unstructured data storage function (UDSF) and/or in other NF as part of UE data (e.g., UE subscription data) and/or network data, e.g., roaming serving data.

In an implementation, if operator policy of the home network 204 allows rejection report provision without signing, then a NF in the home network 204 on receiving the rejection report 224 can store the rejection report 224 in the UDM, UDR, UDSF, and/or other NF as part of UE data (e.g., UE subscription data) or network data (e.g., roaming serving data) to take actions based on local operator policy. At 230 the home network 204 (e.g., a NF that receives and/or processes the rejection report 224) sends a report acknowledgement (e.g., Success indication, and Reference Identifier) to the visited network (e.g., a NF which provided the slice rejection network report), such as in Nudm_response service operation message and/or Nnf_service rejection network report acknowledgement service operation message.

The following describes example aspects relating to rejection report generation and communication by the UE 104a. These aspects may be performed and/or occur prior to, concurrently with, and/or after the visited network 202 generates the rejection report 224. Further to the system 200, after the UE 104a receives the service rejection at 222 (e.g., in an NAS message from the visited network 202), the UE 104a generates UE rejection report (UE report) 232 which can include various information such as a reference identifier, UE ID (e.g., SUPI), subscribed services (e.g., slice) identification (e.g., S-NSSAIs), service rejection code, service rejection reason, visiting network ID and/or or name (e.g., SN ID, SNN), NF ID, timestamp, and/or combinations thereof.

The UE 104a, for instance, can use a reference identifier if provided by a NF (e.g., AMF 206, SMF 208, etc.) in an NAS message such as previously received based on the registration request at 214. Alternatively or additionally, if the UE 104a receives a freshness parameter from the visited network 202, the UE 104a can derive the reference identifier using the freshness parameter received from the visited network 202. For instance, a reference identifier can be generated as: Hash (UE ID, visited network ID, NF ID, random number, nonce) if provided by the visited network 202).

In implementations, if the UE 104a does not receive a reference identifier or freshness parameter in a message (e.g., in a NAS message) indicating the service rejection and/or slice service rejection, the UE 104a can assign a freshness parameter and derive a reference identifier itself and provide the generated reference identifier to a NF of the visited network 202 (e.g., AMF/SMF) in an acknowledgement message (e.g., in NAS transport) in response to the service rejection at 222.

The UE 104a generates a secure report 234 from the UE report 232. The UE 104a can secure (e.g., confidentiality protection and/or integrity protection) the UE report 232 using a UE context (such as using an authentication server function (AUSF) key (Kausf) or other key derived from it) using one or more of the following implementations. In implementations, for the following options a hash of slice reporting key and/or service reporting key and SUPI can be used as a slice reporting key identifier and/or service reporting key identifier, referred to hereafter individually or in combination as a slice/service reporting key identifier. In implementations the slice/service reporting key identifier can be derived as: Hash (slice/service reporting key identifier∥SUPI).

Implementations for securing the UE report 232 such as to generate the secure report 234:

Example implementation 1a: Using a key directly derived from Kausf:
Slice/Service Reporting Key (e.g., for Confidentiality and/or Integrity) can be derived as:
   KReport_Enc=KDF (Kausf, UE ID, HN ID, Freshness parameter, Slice/Service Reporting Code/Keyword, Confidentiality Code)
   KReport_Int=KDF (Kausf, UE ID, HN ID, Freshness parameter, Slice/Service Reporting Code/Keyword, Integrity Code)

Example implementation 2a: Using a key indirectly derived from Kausf:
Slice/Service Reporting Key can be derived from Kausf first:
   KReport=KDF (Kausf, UE ID, HN ID, Freshness parameter, Slice/Service Reporting Code/Keyword)
      For confidentiality protection of slice rejection UE report:
         KReport_Enc=KDF (KReport, Confidentiality Code)
      For integrity protection of slice rejection UE report:
         KReport_Int=KDF (KReport, Integrity Code)

Example implementation 3a: Using a key derived from preconfigured service reporting key (Kservicereport):
Slice/Service Reporting Key (for Confidentiality and/or Integrity) can be derived as:
   KReport_Enc=KDF (Kservicereport, UE ID, HN ID, Freshness parameter, Slice/Service Reporting Code/Keyword, Confidentiality Code)
   KReport_Int=KDF (Kservicereport, UE ID, HN ID, Freshness parameter, Slice/Service Reporting Code/Keyword, Integrity Code)
The UE 104a and an NF in the home network 204 designated to receive the service/slice service rejection report can be configured with a service reporting key (Kservicereport) which can be specific to the UE subscription and identified with the SUPI of the UE 104a.

Example implementation 4a: Using a key indirectly derived from Kausf, e.g., with an application function key (Kaf) derived from Kausf or an authentication and key management for applications key (Kakma):
Slice/Service Reporting Key (for Confidentiality and/or Integrity) can be derived as:
   Kaf=KDF (Kakma, UE ID, AF ID, HN ID, Freshness parameter, Slice/Service Reporting Code/Keyword)
   Optional KReport_Enc=KDF (Kaf/Kakma, UE ID, HN ID, Freshness parameter, Slice/Service Reporting Code/Keyword, Confidentiality Code)
   Optional KReport_Int=KDF (Kaf/Kakma, UE ID, HN ID, Freshness parameter, Slice/Service Reporting Code/Keyword, Integrity Code)

The example implementation 4 can be used, for instance, to communicate the secure report 234 from the UE 104a to the home network 204 over a user plane (e.g., application layer). The home network 204, for instance, has an application function (e.g., an NF 212) and/or server which can be standalone or co-located with a NF 212 in the home network 204. Further, the example implementation 4 can be used if the UE 104a has a Kakma and/or configured to have Kakma. This implementation, for instance, can be through a direct connection between the UE 104a and the home network 204.

The example implementation 4 can be used for user plane-based service/network slice service failure reporting, where the UE 104a can send an application session establishment request to an AF in the home network 204 which includes an Akma key identifier (A-KID) and slice/service reporting security indication and/or code to get Kaf for the slice/service reporting security freshness parameter. The AF may select an Akma anchor function (AAnF) and request a key by providing the A-KID, AF ID, freshness parameter and slice/service reporting security indication and/or code). The AAnF, for instance, can derive the Kaf as described in example implementation 4. The AAnF can provide the SUPI, Kaf and the Kaf expiration time. The AF can send an Application Session Establishment Response to the UE 104a. The UE 104a and the AF can use the Kaf to protect the UE report 232, e.g., to generate the secure report 234.

At 236 the UE 104a sends the secure report 234 (e.g., in a NAS transport/message) to an NF of the visited network 202 (e.g., AMF 206, SMF 208) from which the service rejection at 222 was received. Different implementations are available for generating and/or securing the secure report 234, including:

Example implementation 1b: Securing the secure report 234 with integrity protection: The secure report 234 can include three parts such as (i) UE report 232, slice/service reporting key identifier and (ii) Hash/MAC of the UE report 232. Further, these parts can be concatenated and/or placed together in the secure report 234. The secure report 234 can be sent (e.g., over an NAS message) and includes different information such as a reference identifier, UE ID (e.g., SUPI), subscribed slice identification related to a service (e.g., S-NSSAIs), service rejection code and/or reason, identifier or name for the visited network 202 (e.g., SN ID/SNN), NF ID, timestamp and hash/MAC of UE report 232. For instance, the hash/MAC is generated using a key specific to the UE context described above, e.g., derived directly/indirectly from Kausf.

Example implementation 2b: Securing the UE report 232 with both confidentiality and integrity protection: The secure report 234 includes parts such as (i) Encrypted UE report 232, (ii) plain text of SUPI, slice/service reporting key identifier, freshness parameter (e.g., which can be referred to as report security information), and (iii) Hash/MAC of the encrypted UE report 232 and remaining plain text (e.g., report security information) of SUPI, Key Identifier, Freshness parameter. These parts can be concatenated and/or placed together in the secure report 234.

In implementations the secure report 234 includes an encrypted UE report 232 which may in turn include a reference identifier, UE ID (e.g., SUPI), Subscribed Slice identification related to a service (e.g., S-NSSAIs), rejection code and/or reason, visited network 202 identifier and/or name (e.g., SN ID/SNN), NF ID, and timestamp (e.g., confidentiality protected) along with report security information and Hash/MAC of the encrypted UE report 232 and report security information, which can be integrity protected using a Key specific to the UE context described above, e.g., derived directly/indirectly from Kausf.

At 238 the visited network 202 (e.g., AMF 206) sends the received secure report 234 to the NF 212, such as based on the local configuration and UE context available, e.g., UE ID, home network NF information including NF address (e.g., IP address) associated with the home network 204. In implementations the visited network 202 can send the secure report 234 to the NF 212 in the home network 204 using an Nudm_service operation message or a Nnf_service rejection UE report notification service operation message.

In an implementation, if the AMF receives the secure report 234 in a session management (SM) message, it can be forwarded to the SMF 208 and the SMF 208 (e.g., based on the local configuration and UE context available (e.g., UE ID, home network NF information including NF 212 address/IP address associated with the home network 204) can send the secure report 234 to the NF 212 in the home network 204, such as using Nudm_service operation message or a Nnf_service rejection UE report notification service operation message.

Further to the system 200, the NF 212 (e.g., UDM, UDR, and/or other NF) in the home network 204 receives the secure report 234 can verify the confidentiality and/or integrity protection of the secure report 234 using a slice/service reporting key (e.g., similar to the key used by the UE 104a) with a root security which can be identified with a SUPI and can be generated based on the SUPI and a freshness parameter along with other information as described above. The generated slice/service reporting key may be validated with a key identifier (e.g., slice/service reporting key identifier) if the key identifier is received from the UE 104a along with the secure report 234.

In implementations, if the NF 212 does not have a security context for the UE 104a locally available, then at 240 the NF 212 sends a key request message (e.g., for slice/service reporting key related to a slice rejection UE report protection/security service) to the AUSF 210 which includes SUPI, Reference identifier, and freshness parameter received from the UE 104a. In implementations other information may be included as part of the key request such as a home network ID, slice/service reporting code/keyword, slice/service reporting key identifier, integrity and/or confidentiality requirement information, and/or combinations thereof.

The AUSF 210 receives the key request (e.g., for slice/service reporting key) and derives the slice/service reporting key and at 242 communicates a key response that includes the slice/service reporting key(s) to the NF 212 which communicated the key request 240. In implementations, if the NF 212 has no security context for the UE 104a locally available, then the NF 212 can send a request message (e.g., for verification of slice rejection UE report protection/security service) to the AUSF 210 which includes information received at the NF 212 described above.

Accordingly, in implementations where the AUSF 210 receives the key request 240, it can derive the slice/service reporting key such as based on the following implementations and performs the verification of secure report 234 and provides a success indication and generated Hash/MAC and/or encrypted UE report 232 to the NF 212 in a response message.

Example Implementation 1c: If the received slice rejection UE report Secured with integrity protection: The NF 212 receives the secure report 234 with (i) the UE report 232, slice/service reporting key identifier and (ii) Hash/MAC of the UE report 232. The NF 212 can identify the UE context (e.g., Kausf, Kakma, Kaf, a network function key (Knf), etc.) using SUPI and generate the slice/service reporting key (e.g., KReport and/or KReport_Int) based on one or more of the implementations described above, and derive the slice/service reporting key identifier such as described above.

If the derived slice/service reporting key identifier is same as the received slice/service reporting key identifier, then the validation of slice/service reporting key identifier can be considered successful. The NF 212 can use the slice/service reporting key to drive the hash/MAC of the received UE report 232 and key identifier, and if the computed hash/MAC is same as the received hash/MAC, then the NF 212 considers the secure report 234 verification as successful.

Example Implementation 2c: If the secure report 234 is secured with both confidentiality and integrity protection: The NF 212 receives the secure report 234 with (i) Encrypted UE report 232, (ii) plain text of SUPI, slice/service reporting key identifier, freshness parameter (which can be referred to as report security information) and (iii) Hash/MAC of information such as the encrypted UE report 232 and remaining plain text such as report security information, SUPI, key identifier, freshness parameter, and so forth. The NF 212 identifies the UE context (e.g., Kausf, Kakma, Kaf, Knf, etc.) using the SUPI and generates the slice/service reporting key (e.g., KReport, KReport_Enc, KReport_Int as discussed above) and derives the slice/service reporting key identifier.

In implementations, if the derived slice/service reporting key identifier is same as the received slice/service reporting key identifier, then the validation of slice/service reporting key identifier is considered successful. The NF 212 can use the slice/service reporting key to drive the hash/MAC of the received information in the secure report 234, and if the computed hash/MAC is same as the received hash/MAC, then the NF 212 considers the secure report 234 verification as successful.

Accordingly, report verification 244 is performed as described in the various implementations above to verify the authenticity, security, and/or validity of the secure report 234. The NF 212 can store the secure report 234 along with the SUPI such as in a UDM, UDR, UDSF, and/or other NF either separately along the UE subscription data or can store the secure report 234 along with the rejection report 224 received from the visited network 202, and/or in network data, e.g., roaming serving data.

At 246 the NF 212, based on a successful report verification 244 of the received secure report 234, sends a report acknowledgement (e.g., as an ACK indication to denote successful reception of the secure report 234 and additional information such as the received reference identifier), and a MAC of the acknowledgement to the AMF 206, e.g., which provided the secure report at 238. The acknowledgement, for instance, may be communicated in a Nudm_response service operation message or a Nnf_service rejection UE report acknowledgement service operation message. In implementations the MAC for the UE report acknowledgement can be generated using a same slice/service reporting key used for verification of the secure report 234, e.g., KReport, KReport_Int such as described above. In implementations the MAC can be generated as: key derivation function (KDF) and/or Hash function: acknowledgement notification: Success indication, Reference Identifier, slice/service reporting key.

At 248 the AMF 206 forwards the acknowledgement (e.g., Success indication, Reference Identifier) and MAC to the UE 104a, such as in the NAS transport, e.g., a N1 message. The UE 104a receives the report acknowledgement with success indication and can perform report verification 250 to check the received MAC using the slice/service reporting key used for the protection of the UE report 232 related to the indicated reference identifier. If the computed MAC and received MAC matches, the UE 104a considers the slice rejection UE report acknowledgement verification as successful.

Based on the various reports from the visited network 202 and/or the UE 104a (e.g., the rejection report 224, the UE report 232, and/or the secure report 234) and/or based on operator policy, the NF 212 in the home network 204 generates network preferences 252 to provide preferred visited networks, e.g., preferred VPLMNs, SNPNs, etc. The network preferences 252, for instance, list prioritized visited networks such as in an order of subscriber slice serving capabilities. The network preferences 252, for instance, can be used by the UE 104a for Steering of roaming (SoR) procedures, UE parameter update procedures, for a new home network subscription specific serving Network selection information update, and/or for a provisioning procedure such as described below.

In implementations, the home network 204 can use the received UE and/or network provided slice rejection report(s) to determine and trigger potential actions such as one or more of: To provide/configure the UE 104a with additional preferred visited network list information prioritized based on the capability to serve all or most of the subscribed services or network slices of subscribed UEs; and/or future service level agreement-based conflict resolution and/or payment/charging handling for roaming services.

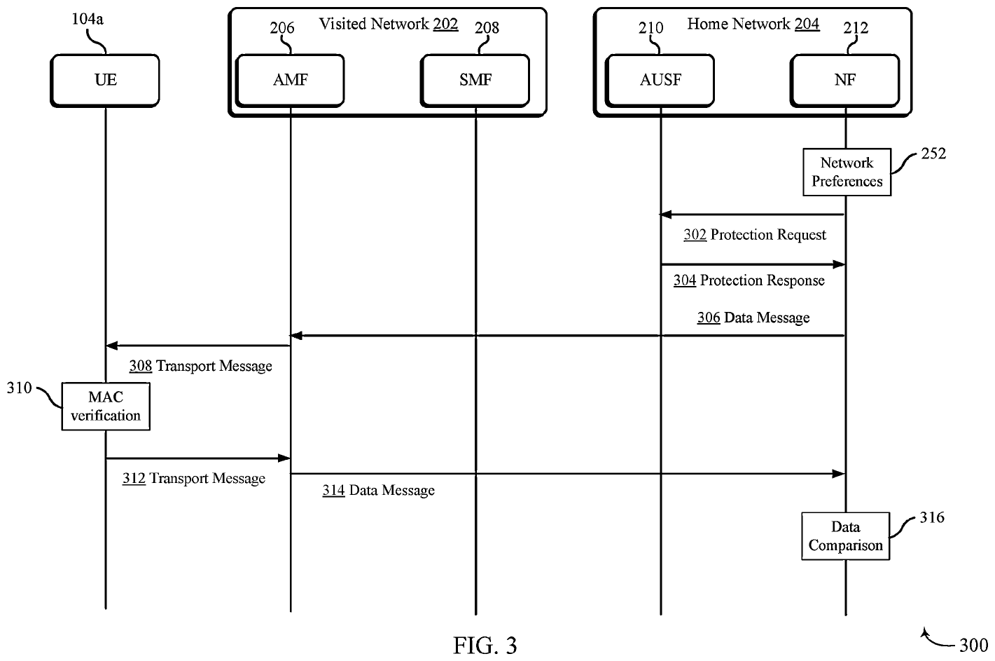

FIG. 3 illustrates an example of a system 300 that supports service management in wireless networks in accordance with aspects of the present disclosure. The system 300 may use the wireless communications system 100 and/or be implemented with the wireless communications system 100. The system 300, for instance, represents an extension of and/or variation on the system 200.

In the system 300 the NF 212 has access to the network preferences 252, such as described above. Accordingly, at 302 the NF 212 sends a protection request to the AUSF 210 (e.g., as part of a Nausf_service operation) which includes SUPI, the network preferences 252, data as part of new slice serving network data and/or as part of an SoR list or UE parameter update (UPU) data, acknowledgement indication, and a secured packet, to the AUSF 210. At 304 the AUSF 210 sends a protection response 304 that includes a Data-MAC-I_{AUSF} and Counter_{Data}. The NF 212, for instance, selects the AUSF 210 associated with a latest K_{AUSF} or slice/service reporting key of the UE 104a. In implementations, if the home network 204 decides that the UE 104a is to acknowledge a successful security check of received slice serving network data/SoR Information/UE parameter update data, the NF 212 can set accordingly the ACK Indication included in the Nausf_DataProtection service operation message to signal that it also requests Data-XMAC-IUE, as specified below:

When deriving a Data-XMAC-IAUSF from KAUSF or Slice/Service Reporting Key, the following parameters can be used to form the input S to the KDF:
FC=0×77,
P0=Data header,
L0=length of Data header,
P1=CounterData,
L1=length of CounterData,
P2=preferred VPLMN/SNPN list prioritized in the order of subscriber slice serving capability(ies) or secured packet,
L2=length of list of preferred VPLMN/SNPN list prioritized in the order of subscriber slice serving capability(ies) or secured packet.
The input key KEY can be KAUSF or slice/service reporting key.

In implementations, at reception of Nausf_DataProtection Protect request from the NF 212, if the Data header is not included in the request, the AUSF 210 constructs the Data header, based on the information received from the NF 212, e.g., ACK Indication and optionally the list of preferred PLMN/access technology combinations or secured packet; otherwise, if the Data header in contained in the request, the AUSF 210 uses the received Data header in the calculation of Data-MAC-I_{AUSF}.

The details of the CounterData: The inclusion of the Data and the Data header in the calculation of Data-MAC-I_{AUSF} allows the UE 104a to verify that the Data received is not tampered with or removed by the visited network 202. The inclusion of this information in the calculation of the expected Data-XMAC-IUE allows the NF 212 to verify that the UE 104a received the Data.

At 306 the NF 212 sends a data message to the AMF 206 for forwarding to the UE 104a. As part of the data message, for instance, the NF 212 can invoke a Nudm_SDM_Notification service operation, which contains the Data transparent container (e.g., if the AMF 206 supports Data transparent container), or contains individual information elements including an optional list of preferred visited networks/access technology combinations or secured packet, the ACK Indication, Data-MAC-I_{AUSF}, and CounterData within the Access and Mobility Subscription data. If the NF 212 requests an acknowledgement from the UE 104a, it can temporarily store the expected Data-XMAC-IUE.

After receiving the data message (e.g., Nudm_SDM_Notification message), if the Data transparent container is included in the message, at 308 the AMF 206 sends a transport message (e.g., a DL NAS Transport message) to the UE 104a including the received Data transparent container. Alternatively or additionally, the AMF 206 can construct the Data transparent container (including the Data header) based on the ACK Indication, the Data, Data-MAC-I_{AUSF} and CounterData received from the NF 212, and send the constructed Data transparent container included to the UE 104a in a DL NAS Transport message.

The UE 104a receives the transport message and can calculate the Data-MAC-I_{AUSF}, e.g., in a same way as the AUSF 210 described above on the received Data transparent container, including the Counter Data and the Data header and perform MAC verification 310 to verify whether the MAC matches the Data-MAC-I_{AUSF} value received in the transport message.

In implementations, when deriving a Data-MAC-I_{AUSF} from K_{AUSF} and/or a slice/service reporting key, the following parameters can be used to form the input S to the KDF.
FC=0×77,
P0=Data header,
L0=length of Data header,
P1=CounterData,
L1=length of CounterData,
P2=preferred PLMN/SNPN list prioritized in the order of subscriber slice serving capability(ies) or secured packet,
L2=length of list of preferred PLMN/SNPN list prioritized in the order of subscriber slice serving capability(ies) or secured packet.
The input key KEY can be KAUSF or Slice/Service Reporting Key.

In implementations, if the NF 212 has requested an acknowledgement from the UE 104a and the UE 104a verified that the Steering Information has been provided by the home network 204, then at 312 the UE 104a can send a transport message (e.g., UL NAS Transport) message to the AMF 206. The UE 104a can generate the Data-MAC-IUE as follows and includes the generated Data-MAC-IUE in a Data transparent container in the transport message.

When deriving a Data-MAC-IUE from K_{AUSF}, the following parameters can be used to form the input S to the KDF:
FC=0×78,
P0=0×01 (Data Acknowledgement: Verified the Slice Serving Network Data which can indicate preferred PLMN/SNPN list (prioritized in the order of subscriber slice serving capability(ies) successfully),
L0=length of Data Acknowledgement (e.g. 0×00 0×01),
P1=CounterData,
L1=length of CounterData.
The input key KEY can be KAUSF or Slice/Service Reporting Key.
The Data-MAC-IUE is identified with the 128 least significant bits of the output of the KDF.

At 314 the AMF 206 can send a data message (e.g., Nudm_SDM_Info request message) to the NF 212. If a Data transparent container with the Data-MAC-IUE was received in the transport message, the AMF 206 can include the received Data transparent container in the data message request message if the AMF 206 supports Data transparent container, otherwise, the AMF 206 can include the Data-MAC-IUE in the data message.

If the home network 204 indicated that the UE 104a is to acknowledge the successful security check of the received Data, then the NF 212 performs data comparison 316 to compare the received Data-MAC-IUE with the expected Data-XMAC-IUE that the NF 212 stored temporarily as indicated above.

As discussed above, data can refer to Slice Serving Network Data which can indicate preferred visited networks list, such as prioritized in the order of subscriber slice serving capabilities and/or based on the operator policy, configurations, roaming SLA (e.g., configured by the operations, administration and management/maintenance (OAM).

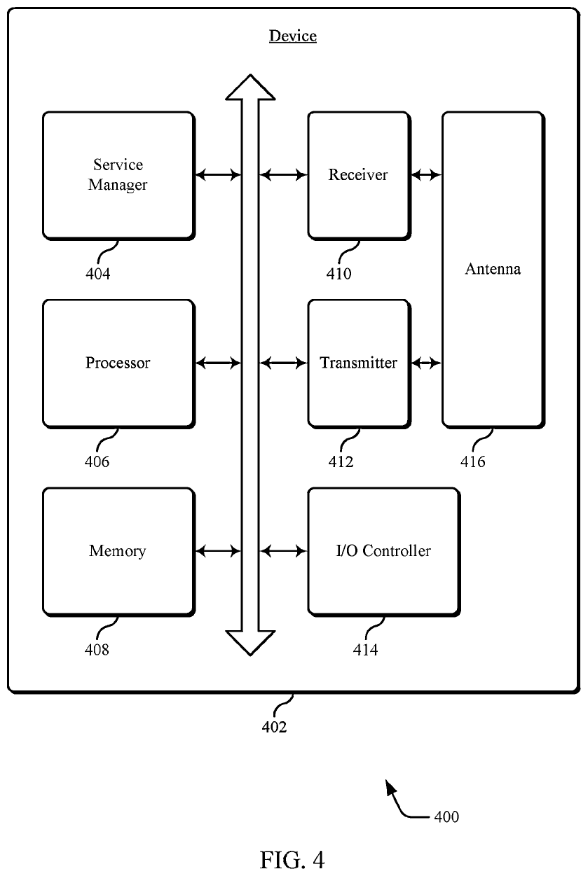

FIG. 4 illustrates an example of a block diagram 400 of a device 402 that supports service management in wireless networks in accordance with aspects of the present disclosure. The device 402 may be an example of a UE 104 as described herein. The device 402 may support wireless communication and/or network signaling with one or more base stations 102, other UEs 104, network entities and devices, or any combination thereof. The device 402 may include components for bi-directional communications including components for transmitting and receiving communications, such as a service manager 404, a processor 406, a memory 408, a receiver 410, a transmitter 412, and an I/O controller 414. These components may be in electronic communication or otherwise coupled (e.g., operatively, communicatively, functionally, electronically, electrically) via one or more interfaces (e.g., buses).

The service manager 404, the receiver 410, the transmitter 412, or various combinations thereof or various components thereof may be examples of means for performing various aspects of the present disclosure as described herein. For example, the service manager 404, the receiver 410, the transmitter 412, or various combinations or components thereof may support a method for performing one or more of the functions described herein.

In some implementations, the service manager 404, the receiver 410, the transmitter 412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 406 and the memory 408 coupled with the processor 406 may be configured to perform one or more of the functions described herein (e.g., by executing, by the processor 406, instructions stored in the memory 408).

Additionally or alternatively, in some implementations, the service manager 404, the receiver 410, the transmitter 412, or various combinations or components thereof may be implemented in code (e.g., as communications management software or firmware) executed by the processor 406. If implemented in code executed by the processor 406, the functions of the service manager 404, the receiver 410, the transmitter 412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the service manager 404 may be configured to perform various operations (e.g., receiving, monitoring, transmitting) using or otherwise in cooperation with the receiver 410, the transmitter 412, or both. For example, the service manager 404 may receive information from the receiver 410, send information to the transmitter 412, or be integrated in combination with the receiver 410, the transmitter 412, or both to receive information, transmit information, or perform various other operations as described herein. Although the service manager 404 is illustrated as a separate component, in some implementations, one or more functions described with reference to the service manager 404 may be supported by or performed by the processor 406, the memory 408, or any combination thereof. For example, the memory 408 may store code, which may include instructions executable by the processor 406 to cause the device 402 to perform various aspects of the present disclosure as described herein, or the processor 406 and the memory 408 may be otherwise configured to perform or support such operations.

For example, the service manager 404 may support wireless communication and/or network signaling at a device (e.g., the device 402, a UE) in accordance with examples as disclosed herein. The service manager 404 and/or other device components may be configured as or otherwise support an apparatus, such as a UE, including a transceiver; a processor coupled to the transceiver, the processor and the transceiver configured to cause the apparatus to: receive a first message indicating a service rejection for a service associated with a network slice and UE subscription data, the first message including service rejection information; generate, based at least in part on the received first message, a second message indicating the service rejection and a reference identifier associated with the service rejection; generate a key to protect the second message; generate a secured second message using the key and the second message; and transmit the secured second message.

Additionally, the apparatus (e.g., a UE) includes any one or combination of: where to generate the secured second message, the processor and the transceiver are further configured to use the key to generate a hashed message authentication code of the second message to generate at least a portion of the secured second message; where the processor and the transceiver are further configured to generate the reference identifier using a function with one or more of a UE identifier, a network function identifier, a visited network identifier, or a freshness parameter; where the freshness parameter includes one or more of a random number, a nonce, or a counter; where to generate the secured second message, the processor and the transceiver are further configured to use the key, the second message, and a function with one or more of sender information, a UE identifier, a network function identifier, a visited network identifier, subscribed slice identification information, subscribed service identification information, failure cause information, a timestamp, a key identifier, a freshness parameter, or a slice service reporting code; where the processor and the transceiver are further configured to cause the UE to transmit a key identifier for the key with the secured second message; where the key includes one or more of an authentication server function (AUSF) key, a slice service reporting key, or an authentication and key management for applications (AKMA) key, a key derived from an authentication server function (AUSF), a key derived from a slice service reporting key, a key derived from an authentication and key management for applications (AKMA) key, and input parameters;

Further, where the input parameters used for the key generation include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof; where the key includes one or more of a slice reporting root key, an integrity key, a confidentiality key, or combinations thereof; where the processor and the transceiver are further configured to cause the UE to receive, based on the secured second message, slice serving network data including a preferred visited network list for slice services for the UE; where the preferred visited network list is prioritized based on visited network service capabilities; where the first message is received from a visited network, and where the processor and the transceiver are further configured to cause the UE to transmit the secured second message via a control plane communication to the visited network for forwarding to a home network of the UE; where the first message is received from a visited network, and where the processor and the transceiver are further configured to cause the UE to transmit the secured second message via a user plane communication to a home network of the UE; where to transmit the secured second message via the user plane communication, the processor and the transceiver are further configured to cause the UE to: generate a further key; transmit, to an application function of the home network, an application session establishment request including a key identifier and information related to slice service reporting; receive, from the application function of the home network, an application session establishment response to establish an application session between the UE and the application function; and communicate the secured second message to the application function using the application session;

Further, where the information related to slice service reporting includes one or more of a slice service reporting security indication, a slice service reporting security required indication, a slice service reporting security code, or a freshness parameter; where the further key includes an application function key associated with the application function of the home network, and the key identifier identifies the application function key; where the processor and the transceiver are further configured to cause the UE to derive the application function key using a key derivation function and an authentication and key management for applications (AKMA) key, a UE identifier, an application function identifier, a home network identifier, a freshness parameter, and a slice service reporting code keyword; where the processor and the transceiver are further configured to cause the UE to: receive a third message indicating acknowledgement of the secured second message; and verify the third message using the key.

The service manager 404 and/or other device components may be configured as or otherwise support a means for wireless communication and/or network signaling at a UE, including receiving a first message indicating a service rejection for a service associated with a network slice and UE subscription data, the first message including service rejection information; generating, based at least in part on the receiving the first message, a second message indicating the service rejection and a reference identifier associated with the service rejection; generating a key to protect the second message; generating a secured second message using the key and the second message; and transmitting the secured second message.

Additionally, wireless communication and/or network signaling at the UE includes any one or combination of: where generating the secured second message includes using the key to generating a hashed message authentication code of the second message to generating at least a portion of the secured second message; where generating the reference identifier includes using a function with one or more of a UE identifier, a network function identifier, a visited network identifier, or a freshness parameter; where the freshness parameter includes one or more of a random number, a nonce, or a counter; where generating the secured second message includes using the key, the second message, and a function with one or more of sender information, a UE identifier, a network function identifier, a visited network identifier, subscribed slice identification information, subscribed service identification information, failure cause information, a timestamp, a key identifier, a freshness parameter, or a slice service reporting code; further including causing the UE to transmit a key identifier for the key with the secured second message; where the key includes one or more of an authentication server function (AUSF) key, a slice service reporting key, or an authentication and key management for applications (AKMA) key, a key derived from an authentication server function (AUSF), a key derived from a slice service reporting key, a key derived from an authentication and key management for applications (AKMA) key, and input parameters; where the input parameters used for the key generation include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof;

Further, where the key includes one or more of a slice reporting root key, an integrity key, a confidentiality key, or combinations thereof; further including receiving, based on the secured second message, slice serving network data including a preferred visited network list for slice services for the UE; where the preferred visited network list is prioritized based on visited network service capabilities; where the first message is received from a visited network, and where the method further includes transmitting the secured second message via a control plane communication to the visited network for forwarding to a home network of the UE; where the first message is received from a visited network, and where the method further includes transmitting the secured second message via a user plane communication to a home network of the UE; where transmitting the secured second message via the user plane communication includes: generating a further key; transmitting, to an application function of the home network, an application session establishment request including a key identifier and information related to slice service reporting; receiving, from the application function of the home network, an application session establishment response to establish an application session between the UE and the application function; and communicating the secured second message to the application function using the application session; where the information related to slice service reporting includes one or more of a slice service reporting security indication, a slice service reporting security required indication, a slice service reporting security code, or a freshness parameter; where the further key includes an application function key associated with the application function of the home network, and the key identifier identifies the application function key; further including deriving the application function key using a key derivation function and an authentication and key management for applications (AKMA) key, a UE identifier, an application function identifier, a home network identifier, a freshness parameter, and a slice service reporting code keyword; further including: receiving a third message indicating acknowledgement of the secured second message; and verify the third message using the key;

The processor 406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 406 may be configured to operate a memory array using a memory controller. In some other implementations, a memory controller may be integrated into the processor 406. The processor 406 may be configured to execute computer-readable instructions stored in a memory (e.g., the memory 408) to cause the device 402 to perform various functions of the present disclosure.

The memory 408 may include random access memory (RAM) and read-only memory (ROM). The memory 408 may store computer-readable, computer-executable code including instructions that, when executed by the processor 406 cause the device 402 to perform various functions described herein. The code may be stored in a non-transitory computer-readable medium such as system memory or another type of memory. In some implementations, the code may not be directly executable by the processor 406 but may cause a computer (e.g., when compiled and executed) to perform functions described herein. In some implementations, the memory 408 may include, among other things, a basic I/O system (BIOS) which may control basic hardware or software operation such as the interaction with peripheral components or devices.

The I/O controller 414 may manage input and output signals for the device 402. The I/O controller 414 may also manage peripherals not integrated into the device 402. In some implementations, the I/O controller 414 may represent a physical connection or port to an external peripheral. In some implementations, the I/O controller 414 may utilize an operating system such as iOS®, ANDROID®, MS-DOS®, MS-WINDOWS®, OS/2®, UNIX®, LINUX®, or another known operating system. In some implementations, the I/O controller 414 may be implemented as part of a processor, such as the processor 406. In some implementations, a user may interact with the device 402 via the I/O controller 414 or via hardware components controlled by the I/O controller 414.

In some implementations, the device 402 may include a single antenna 416. However, in some other implementations, the device 402 may have more than one antenna 416, which may be capable of concurrently transmitting or receiving multiple wireless transmissions. The receiver 410 and the transmitter 412 may communicate bi-directionally, via the one or more antennas 416, wired, or wireless links as described herein. For example, the receiver 410 and the transmitter 412 may represent a wireless transceiver and may communicate bi-directionally with another wireless transceiver. The transceiver may also include a modem to modulate the packets, to provide the modulated packets to one or more antennas 416 for transmission, and to demodulate packets received from the one or more antennas 416.

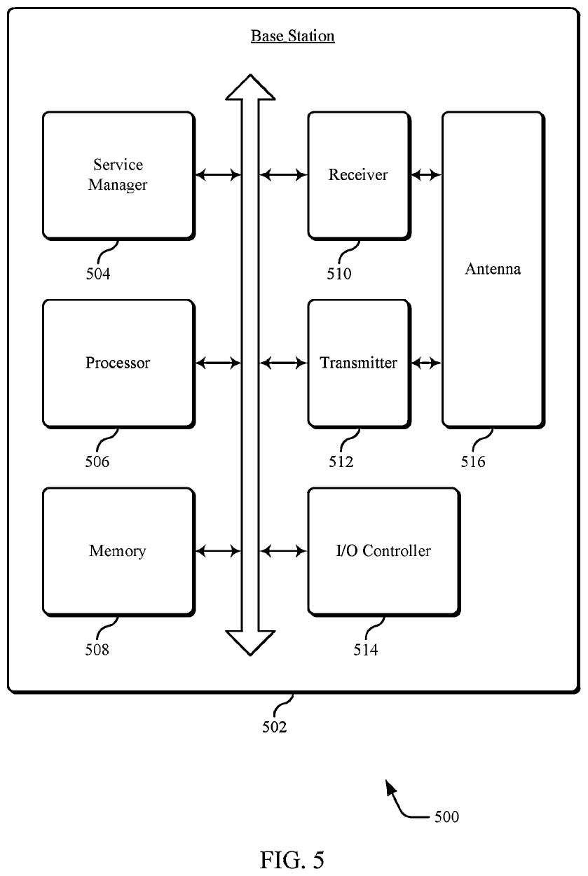

FIG. 5 illustrates an example of a block diagram 500 of a device 502 that supports service management in wireless networks in accordance with aspects of the present disclosure. The device 502 may be an example of a base station 102, such as a gNB as described herein. The device 502 may support wireless communication and/or network signaling with one or more base stations 102, other UEs 104, core network devices and functions (e.g., core network 106), or any combination thereof. The device 502 may include components for bi-directional communications including components for transmitting and receiving communications, such as a service manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The service manager 504, the receiver 510, the transmitter 512, or various combinations thereof or various components thereof may be examples of means for performing various aspects of the present disclosure as described herein. For example, the service manager 504, the receiver 510, the transmitter 512, or various combinations or components thereof may support a method for performing one or more of the functions described herein.

In some implementations, the service manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the service manager 504, the receiver 510, the transmitter 512, or various combinations or components thereof may be implemented in code (e.g., as communications management software or firmware) executed by the processor 506. If implemented in code executed by the processor 506, the functions of the service manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the service manager 504 may be configured to perform various operations (e.g., receiving, monitoring, transmitting) using or otherwise in cooperation with the receiver 510, the transmitter 512, or both. For example, the service manager 504 may receive information from the receiver 510, send information to the transmitter 512, or be integrated in combination with the receiver 510, the transmitter 512, or both to receive information, transmit information, or perform various other operations as described herein. Although the service manager 504 is illustrated as a separate component, in some implementations, one or more functions described with reference to the service manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the service manager 504 may support wireless communication and/or network signaling at a device (e.g., the device 502, a base station) in accordance with examples as disclosed herein.

The service manager 504 and/or other device components may be configured as or otherwise support an apparatus, such as a base station, including a transceiver; a processor coupled to the transceiver, the processor and the transceiver configured to cause the apparatus to: receive, at a visited network from a UE, a service request for access to a service associated with a network slice; reject, based on a condition, the service request; generate a message that includes a UE identifier for the UE, an identifier for the service associated with the network slice, and service rejection information; and transmit the message to a home network of the UE.

Additionally, the apparatus (e.g., a base station) includes any one or combination of: where the processor and the transceiver are configured to cause the apparatus to generate the message to include one or more of a service rejection code, a service rejection reason (e.g., cause code or value), an identifier for the visited network, a network function identifier, a time stamp, or a digital signature; where the processor and the transceiver are configured to cause the apparatus to transmit the message to a function (e.g., UDM or any NF/AF) in the home network using one or more of a reporting address for reporting slice service information to the home network, or a fully qualified domain name (FQDN) associated with the home network; where the processor and the transceiver are configured to cause the apparatus to receive, from the home network, an acknowledgement of the message; where the processor and the transceiver are configured to cause the apparatus to: receive, from the UE, a second message based on the rejected service request; and transmit the second message to the home network of the UE.

The service manager 504 and/or other device components may be configured as or otherwise support a means for wireless communication and/or network signaling at a base station, including receiving, at a visited network from a UE, a service request for access to a service associated with a network slice; rejecting, based on a condition, the service request; generating a message that includes a UE identifier for the UE, an identifier for the service associated with the network slice, and service rejection information; and transmitting the message to a home network of the UE.

Additionally, wireless communication at the base station includes any one or combination of: further including generating the message to include one or more of a service rejection code, a service rejection reason (e.g., cause code or value), an identifier for the visited network, a network function identifier, a time stamp, or a digital signature; further including transmitting the message to a function (e.g., UDM or any NF/AF) in the home network using one or more of a reporting address for reporting slice service information to the home network, or a fully qualified domain name (FQDN) associated with the home network; further including receiving, from the home network, an acknowledgement of the message; further including: receiving, from the UE, a second message based on the rejected service request; and transmitting the second message to the home network of the UE;

The service manager 504 and/or other device components may be configured as or otherwise support an apparatus, such as a base station, including a transceiver; a processor coupled to the transceiver, the processor and the transceiver configured to cause the apparatus to: receive a secured first message generated by a UE, the secured first message including a UE identifier and indicating that the secured first message is associated with a service rejection; and verify the secured first message using a key associated with one or more of the UE identifier or the service rejection.

Additionally, the apparatus (e.g., a base station) includes any one or combination of: where the processor and the transceiver are configured to cause the apparatus to: receive a key identifier from the UE; derive the key and a key identifier; and validate the key using the key identifier; where input parameters used to derive the key include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof; where the key includes one or more of a slice reporting root key, an integrity key, a confidentiality key, or combinations thereof; where the key is derived by an authentication server function (AUSF), a unified data management (UDM), or other network function; where the processor and the transceiver are configured to cause the apparatus to: communicate a key request including one or more of the UE identifier, a reference identifier associated with the secured first message, or a freshness parameter received from the UE; and receive the key based on the key request;

Further, where the processor and the transceiver are configured to cause the apparatus to: receive a first hash value associated with the secured first message; apply a hash function to the secured first message using the key to generate a second hash value; and compare the second hash value to the first hash value to determine whether to verify the secured first message; where the secured first message is encrypted, and where the processor and the transceiver are configured to cause the apparatus to decrypt the secured first message with the key if the second hash value matches the first hash value; where the processor and the transceiver are configured to cause the apparatus to: receive, from a visited network, a second message including the UE identifier and an indication that the second message is associated with the service rejection; and compare the second message to the secured first message to determine whether to validate the second message; where the processor and the transceiver are configured to cause the apparatus to receive the secured first message via a user plane communication from the UE; where to receive the secured first message via the user plane communication, the processor and the transceiver are configured to cause the apparatus to: receive, at an application function, an application session establishment request including a key identifier and information related to slice service reporting; transmit, from the application function, an application session establishment response to establish an application session between the UE and the application function; and receive the secured first message at the application function using the application session;

Further, where the information related to slice service reporting includes one or more of a slice service reporting security indication, a slice service reporting security required indication, a slice service reporting security code, or a freshness parameter; where the application session establishment request further includes a freshness parameter, and where the processor and the transceiver are configured to cause the apparatus to: communicate a key request to a AKMA anchor function (AAnF) that includes one or more of the key identifier, Slice/Service Reporting security indication (or code), or the freshness parameter; and receive the key based on the key request; where the application function includes a network function of a home network of the UE; where the processor and the transceiver are configured to cause the apparatus to: generate, based on the verified secured first message, a second message including a preferred visited network list for services for the UE; and transmit the second message to the UE; where the processor and the transceiver are configured to cause the apparatus to generate the preferred visited network list by prioritizing respective visited networks based on their respective service capabilities;

The service manager 504 and/or other device components may be configured as or otherwise support a means for wireless communication and/or network signaling at a base station, including receiving a secured first message generated by a UE, the secured first message including a UE identifier and indicating that the secured first message is associated with a service rejection; and verifying the secured first message using a key associated with one or more of the UE identifier or the service rejection.

Additionally, wireless communication at the base station includes any one or combination of: further including: receiving a key identifier from the UE; deriving the key and a key identifier; and validating the key using the key identifier; where input parameters used to derive the key include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof; where the key includes one or more of a slice reporting root key, an integrity key, a confidentiality key, or combinations thereof; where the key is derived by an authentication server function (AUSF), a unified data management (UDM), or other network function; further including: communicating a key request including one or more of the UE identifier, a reference identifier associated with the secured first message, or a freshness parameter received from the UE; and receiving the key based on the key request; further including: receiving a first hash value associated with the secured first message; applying a hash function to the secured first message using the key to generating a second hash value; and comparing the second hash value to the first hash value to determine whether to verify the secured first message;

Further, where the secured first message is encrypted, and further including decrypt the secured first message with the key if the second hash value matches the first hash value; further including: receiving, from a visited network, a second message including the UE identifier and an indication that the second message is associated with the service rejection; and comparing the second message to the secured first message to determine whether to validate the second message; further including receiving the secured first message via a user plane communication from the UE; where receiving the secured first message via the user plane communication includes: receiving, at an application function, an application session establishment request including a key identifier and information related to slice service reporting; transmitting, from the application function, an application session establishment response to establish an application session between the UE and the application function; and receiving the secured first message at the application function using the application session; where the information related to slice service reporting includes one or more of a slice service reporting security indication, a slice service reporting security required indication, a slice service reporting security code, or a freshness parameter; where the application session establishment request further includes a freshness parameter, and further including: communicating a key request to a AKMA anchor function (AAnF) that includes one or more of the key identifier, Slice/Service Reporting security indication (or code), or the freshness parameter; and receiving the key based on the key request; where the application function includes a network function of a home network of the UE; further including: generating, based on the verified secured first message, a second message including a preferred visited network list for services for the UE; and transmitting the second message to the UE; further including generating the preferred visited network list by prioritizing respective visited networks based on their respective service capabilities;

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

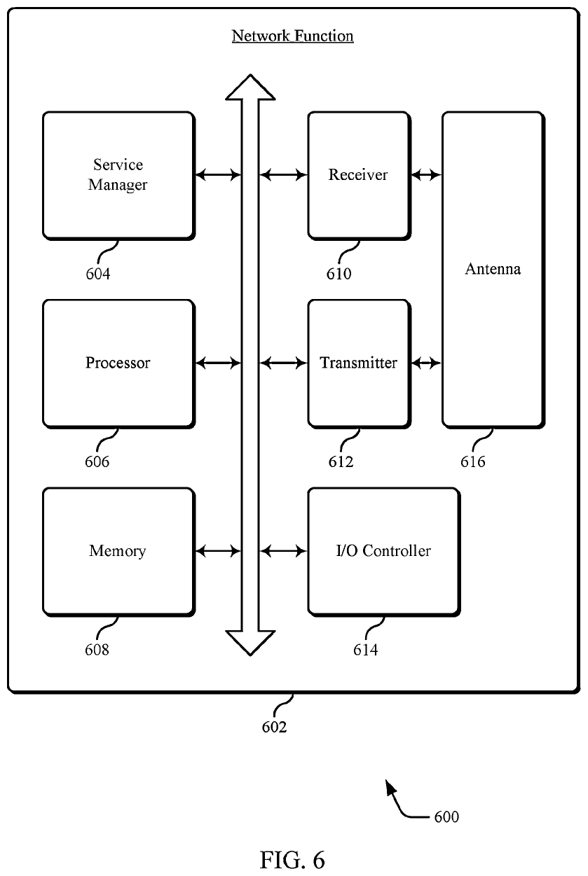

FIG. 6 illustrates an example of a block diagram 600 of a device 602 that supports service management in wireless networks in accordance with aspects of the present disclosure. The device 602 may be an example of a network function (NF) as described herein. The device 602 may support wireless communication and/or network signaling with one or more base stations 102, other UEs 104, core network devices and functions (e.g., core network 106), or any combination thereof. The device 602 may include components for bi-directional communications including components for transmitting and receiving communications, such as a service manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The service manager 604, the receiver 610, the transmitter 612, or various combinations thereof or various components thereof may be examples of means for performing various aspects of the present disclosure as described herein. For example, the service manager 604, the receiver 610, the transmitter 612, or various combinations or components thereof may support a method for performing one or more of the functions described herein.

In some implementations, the service manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the service manager 604, the receiver 610, the transmitter 612, or various combinations or components thereof may be implemented in code (e.g., as communications management software or firmware) executed by the processor 606. If implemented in code executed by the processor 606, the functions of the service manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the service manager 604 may be configured to perform various operations (e.g., receiving, monitoring, transmitting) using or otherwise in cooperation with the receiver 610, the transmitter 612, or both. For example, the service manager 604 may receive information from the receiver 610, send information to the transmitter 612, or be integrated in combination with the receiver 610, the transmitter 612, or both to receive information, transmit information, or perform various other operations as described herein. Although the service manager 604 is illustrated as a separate component, in some implementations, one or more functions described with reference to the service manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the service manager 604 may support wireless communication and/or network signaling at a device (e.g., the device 602, a network function device) in accordance with examples as disclosed herein.

The service manager 604 and/or other device components may be configured as or otherwise support an apparatus, such as a network function, including a transceiver; a processor coupled to the transceiver, the processor and the transceiver configured to cause the apparatus to: receive, at a visited network from a UE, a service request for access to a service associated with a network slice; reject, based on a condition, the service request; generate a message that includes a UE identifier for the UE, an identifier for the service associated with the network slice, and service rejection information; and transmit the message to a home network of the UE.

Additionally, the apparatus (e.g., a network function) includes any one or combination of: where the processor and the transceiver are configured to cause the apparatus to generate the message to include one or more of a service rejection code, a service rejection reason (e.g., cause code or value), an identifier for the visited network, a network function identifier, a time stamp, or a digital signature; where the processor and the transceiver are configured to cause the apparatus to transmit the message to a function (e.g., UDM or any NF/AF) in the home network using one or more of a reporting address for reporting slice service information to the home network, or a fully qualified domain name (FQDN) associated with the home network; where the processor and the transceiver are configured to cause the apparatus to receive, from the home network, an acknowledgement of the message; where the processor and the transceiver are configured to cause the apparatus to: receive, from the UE, a second message based on the rejected service request; and transmit the second message to the home network of the UE.

The service manager 604 and/or other device components may be configured as or otherwise support a means for wireless communication and/or network signaling at a network function, including receiving, at a visited network from a UE, a service request for access to a service associated with a network slice; rejecting, based on a condition, the service request; generating a message that includes a UE identifier for the UE, an identifier for the service associated with the network slice, and service rejection information; and transmitting the message to a home network of the UE.

Additionally, wireless communication at the network function includes any one or combination of: further including generating the message to include one or more of a service rejection code, a service rejection reason (e.g., cause code or value), an identifier for the visited network, a network function identifier, a time stamp, or a digital signature; further including transmitting the message to a function (e.g., UDM or any NF/AF) in the home network using one or more of a reporting address for reporting slice service information to the home network, or a fully qualified domain name (FQDN) associated with the home network; further including receiving, from the home network, an acknowledgement of the message; further including: receiving, from the UE, a second message based on the rejected service request; and transmitting the second message to the home network of the UE;

The service manager 604 and/or other device components may be configured as or otherwise support an apparatus, such as a network function, including a transceiver; a processor coupled to the transceiver, the processor and the transceiver configured to cause the apparatus to: receive a secured first message generated by a UE, the secured first message including a UE identifier and indicating that the secured first message is associated with a service rejection; and verify the secured first message using a key associated with one or more of the UE identifier or the service rejection.

Additionally, the apparatus (e.g., a network function) includes any one or combination of: where the processor and the transceiver are configured to cause the apparatus to: receive a key identifier from the UE; derive the key and a key identifier; and validate the key using the key identifier; where input parameters used to derive the key include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof; where the key includes one or more of a slice reporting root key, an integrity key, a confidentiality key, or combinations thereof; where the key is derived by an authentication server function (AUSF), a unified data management (UDM), or other network function; where the processor and the transceiver are configured to cause the apparatus to: communicate a key request including one or more of the UE identifier, a reference identifier associated with the secured first message, or a freshness parameter received from the UE; and receive the key based on the key request;

Further, where the processor and the transceiver are configured to cause the apparatus to: receive a first hash value associated with the secured first message; apply a hash function to the secured first message using the key to generate a second hash value; and compare the second hash value to the first hash value to determine whether to verify the secured first message; where the secured first message is encrypted, and where the processor and the transceiver are configured to cause the apparatus to decrypt the secured first message with the key if the second hash value matches the first hash value; where the processor and the transceiver are configured to cause the apparatus to: receive, from a visited network, a second message including the UE identifier and an indication that the second message is associated with the service rejection; and compare the second message to the secured first message to determine whether to validate the second message; where the processor and the transceiver are configured to cause the apparatus to receive the secured first message via a user plane communication from the UE; where to receive the secured first message via the user plane communication, the processor and the transceiver are configured to cause the apparatus to: receive, at an application function, an application session establishment request including a key identifier and information related to slice service reporting; transmit, from the application function, an application session establishment response to establish an application session between the UE and the application function; and receive the secured first message at the application function using the application session;

Further, where the information related to slice service reporting includes one or more of a slice service reporting security indication, a slice service reporting security required indication, a slice service reporting security code, or a freshness parameter; where the application session establishment request further includes a freshness parameter, and where the processor and the transceiver are configured to cause the apparatus to: communicate a key request to a AKMA anchor function (AAnF) that includes one or more of the key identifier, Slice/Service Reporting security indication (or code), or the freshness parameter; and receive the key based on the key request; where the application function includes a network function of a home network of the UE; where the processor and the transceiver are configured to cause the apparatus to: generate, based on the verified secured first message, a second message including a preferred visited network list for services for the UE; and transmit the second message to the UE; where the processor and the transceiver are configured to cause the apparatus to generate the preferred visited network list by prioritizing respective visited networks based on their respective service capabilities;

The service manager 604 and/or other device components may be configured as or otherwise support a means for wireless communication and/or network signaling at a network function, including receiving a secured first message generated by a UE, the secured first message including a UE identifier and indicating that the secured first message is associated with a service rejection; and verifying the secured first message using a key associated with one or more of the UE identifier or the service rejection.

Additionally, wireless communication at the network function includes any one or combination of: further including: receiving a key identifier from the UE; deriving the key and a key identifier; and validating the key using the key identifier; where input parameters used to derive the key include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof; where the key includes one or more of a slice reporting root key, an integrity key, a confidentiality key, or combinations thereof; where the key is derived by an authentication server function (AUSF), a unified data management (UDM), or other network function; further including: communicating a key request including one or more of the UE identifier, a reference identifier associated with the secured first message, or a freshness parameter received from the UE; and receiving the key based on the key request; further including: receiving a first hash value associated with the secured first message; applying a hash function to the secured first message using the key to generating a second hash value; and comparing the second hash value to the first hash value to determine whether to verify the secured first message;

Further, where the secured first message is encrypted, and further including decrypt the secured first message with the key if the second hash value matches the first hash value; further including: receiving, from a visited network, a second message including the UE identifier and an indication that the second message is associated with the service rejection; and comparing the second message to the secured first message to determine whether to validate the second message; further including receiving the secured first message via a user plane communication from the UE; where receiving the secured first message via the user plane communication includes: receiving, at an application function, an application session establishment request including a key identifier and information related to slice service reporting; transmitting, from the application function, an application session establishment response to establish an application session between the UE and the application function; and receiving the secured first message at the application function using the application session; where the information related to slice service reporting includes one or more of a slice service reporting security indication, a slice service reporting security required indication, a slice service reporting security code, or a freshness parameter; where the application session establishment request further includes a freshness parameter, and further including: communicating a key request to a AKMA anchor function (AAnF) that includes one or more of the key identifier, Slice/Service Reporting security indication (or code), or the freshness parameter; and receiving the key based on the key request; where the application function includes a network function of a home network of the UE; further including: generating, based on the verified secured first message, a second message including a preferred visited network list for services for the UE; and transmitting the second message to the UE; further including generating the preferred visited network list by prioritizing respective visited networks based on their respective service capabilities.

The service manager 604 and/or other device components may be configured as or otherwise support an apparatus, such as a network function device, including a transceiver; a processor coupled to the transceiver, the processor and the transceiver configured to cause the apparatus to: receive a key request including one or more of a UE identifier, a reference identifier associated with a secured first message, or a freshness parameter; derive a key based on the key request; and communicate the key.

Additionally, the apparatus (e.g., a network function device) includes any one or combination of: where the apparatus is associated with an authentication server function (AUSF) of a home network of the UE, and where the processor and the transceiver are configured to cause the apparatus to receive the key request from a different network function of the home network, and to communicate the key to the different network function; where the different network function includes a unified data management (UDM) of the home network.

The service manager 604 and/or other device components may be configured as or otherwise support a means for wireless communication and/or network signaling at a network function device, including receiving a key request including one or more of a UE identifier, a reference identifier associated with a secured first message, or a freshness parameter; deriving a key based on the key request; and communicating the key.

Additionally, wireless communication at the network function device includes any one or combination of: where the method is performed by an authentication server function (AUSF) of a home network of the UE, and further including receiving the key request from a different network function of the home network, and to communicating the key to the different network function; where the different network function includes a unified data management (UDM) of the home network.

The service manager 604 and/or other device components may be configured as or otherwise support an apparatus, such as a network function device, including a transceiver; a processor coupled to the transceiver, the processor and the transceiver configured to cause the apparatus to: receive a key request including one or more of an authentication and key management for applications key identifier (A-KID), an application function identifier, a freshness parameter, a slice service reporting security indication, a slice service reporting security code, or combinations thereof; derive a key based on the key request; and communicate the key.

Additionally, the apparatus (e.g., a network function device) includes any one or combination of: where the apparatus is associated with an authentication and key management for applications anchor function (AAnF) of a home network of a UE, and where the processor and the transceiver are configured to cause the apparatus to receive the key request from an application function (AF) of the home network, and to communicate the key to the AF

The service manager 604 and/or other device components may be configured as or otherwise support a means for wireless communication and/or network signaling at a network function device, including receiving a key request including one or more of an authentication and key management for applications key identifier (A-KID), an application function identifier, a freshness parameter, a slice service reporting security indication, a slice service reporting security code, or combinations thereof; deriving the key based on the key request; and communicating the key.

Additionally, wireless communication at the network function device includes any one or combination of: where the method is performed by an authentication and key management for applications anchor function (AAnF) of a home network of a UE, and further including receiving the key request from an application function (AF) of the home network, and to communicating the key to the AF.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

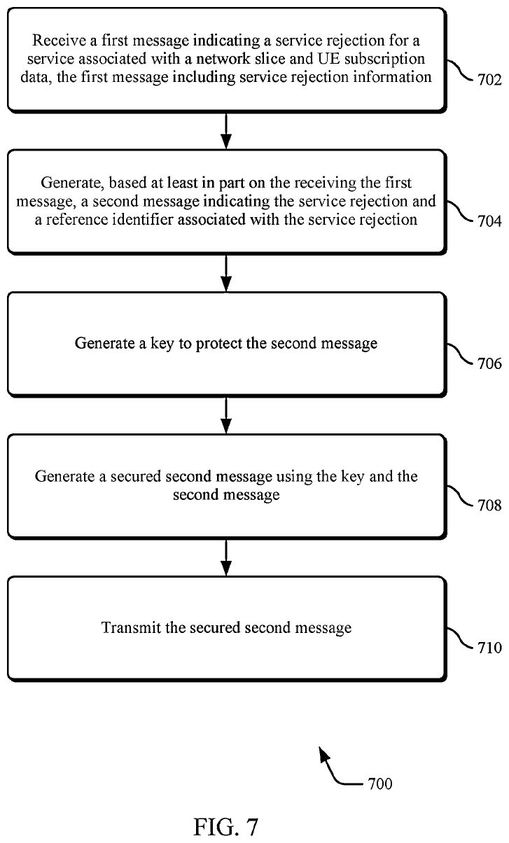

FIG. 7 illustrates a flowchart of a method 700 that supports service management in wireless networks in accordance with aspects of the present disclosure. The operations of the method 700 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include receiving a first message indicating a service rejection for a service associated with a network slice and UE subscription data, the first message including service rejection information. The operations of 702 may be performed in accordance with examples as described herein. In some implementations, aspects of the operations of 702 may be performed by a device as described with reference to FIG. 1.

At 704, the method may include generating, based at least in part on the receiving the first message, a second message indicating the service rejection and a reference identifier associated with the service rejection. The operations of 704 may be performed in accordance with examples as described herein. In some implementations, aspects of the operations of 704 may be performed by a device as described with reference to FIG. 1.

At 706, the method may include generating a key to protect the second message. The operations of 706 may be performed in accordance with examples as described herein. In some implementations, aspects of the operations of 706 may be performed by a device as described with reference to FIG. 1.

At 708, the method may include generating a secured second message using the key and the second message. The operations of 708 may be performed in accordance with examples as described herein. In some implementations, aspects of the operations of 708 may be performed by a device as described with reference to FIG. 1.

At 710, the method may include transmitting the secured second message. The operations of 710 may be performed in accordance with examples as described herein. In some implementations, aspects of the operations of 710 may be performed by a device as described with reference to FIG. 1.

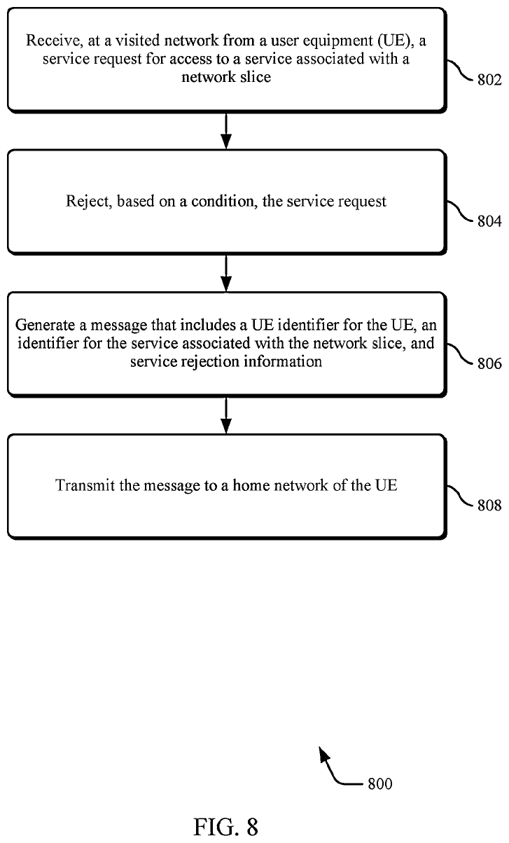

FIG. 8 illustrates a flowchart of a method 800 that supports service management in wireless networks in accordance with aspects of the present disclosure. The operations of the method 800 may be implemented and performed by a device or its components, such as a base station 102 and/or a core network function as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include receiving, at a visited network from a UE, a service request for access to a service associated with a network slice. The operations of 802 may be performed in accordance with examples as described herein. In some implementations, aspects of the operations of 802 may be performed by a device as described with reference to FIG. 1.

At 804, the method may include rejecting, based on a condition, the service request. The operations of 804 may be performed in accordance with examples as described herein. In some implementations, aspects of the operations of 804 may be performed by a device as described with reference to FIG. 1.

At 806, the method may include generating a message that includes a UE identifier for the UE, an identifier for the service associated with the network slice, and service rejection information. The operations of 806 may be performed in accordance with examples as described herein. In some implementations, aspects of the operations of 806 may be performed by a device as described with reference to FIG. 1.

At 808, the method may include transmitting the message to a home network of the UE. The operations of 808 may be performed in accordance with examples as described herein. In some implementations, aspects of the operations of 808 may be performed by a device as described with reference to FIG. 1.

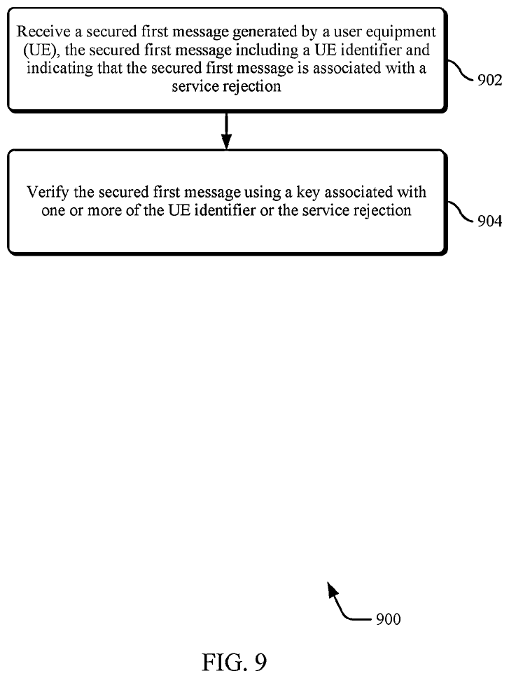

FIG. 9 illustrates a flowchart of a method 900 that supports service management in wireless networks in accordance with aspects of the present disclosure. The operations of the method 900 may be implemented and performed by a device or its components, such as a base station 102 (e.g., gNB) and/or a core network function as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include receiving a secured first message generated by a UE, the secured first message including a UE identifier and indicating that the secured first message is associated with a service rejection. The operations of 902 may be performed in accordance with examples as described herein. In some implementations, aspects of the operations of 902 may be performed by a device as described with reference to FIG. 1.

At 904, the method may include verifying the secured first message using a key associated with one or more of the UE identifier or the service rejection. The operations of 904 may be performed in accordance with examples as described herein. In some implementations, aspects of the operations of 904 may be performed by a device as described with reference to FIG. 1.

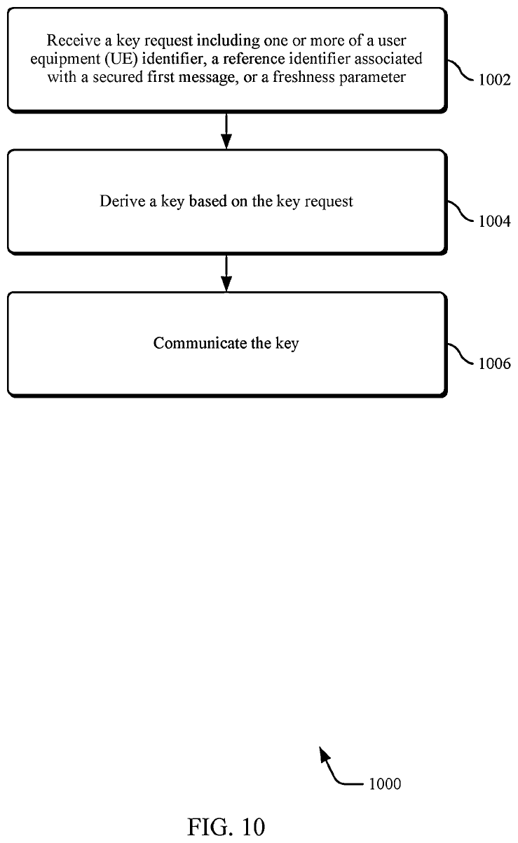

FIG. 10 illustrates a flowchart of a method 1000 that supports service management in wireless networks in accordance with aspects of the present disclosure. The operations of the method 1000 may be implemented and performed by a device or its components, such as a network device (e.g., a core network function) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving a key request including one or more of a UE identifier, a reference identifier associated with a secured first message, or a freshness parameter. The operations of 1002 may be performed in accordance with examples as described herein. In some implementations, aspects of the operations of 1002 may be performed by a device as described with reference to FIG. 1.

At 1004, the method may include deriving a key based on the key request. The operations of 1004 may be performed in accordance with examples as described herein. In some implementations, aspects of the operations of 1004 may be performed by a device as described with reference to FIG. 1.

At 1006, the method may include communicating the key. The operations of 1006 may be performed in accordance with examples as described herein. In some implementations, aspects of the operations of 1006 may be performed by a device as described with reference to FIG. 1.

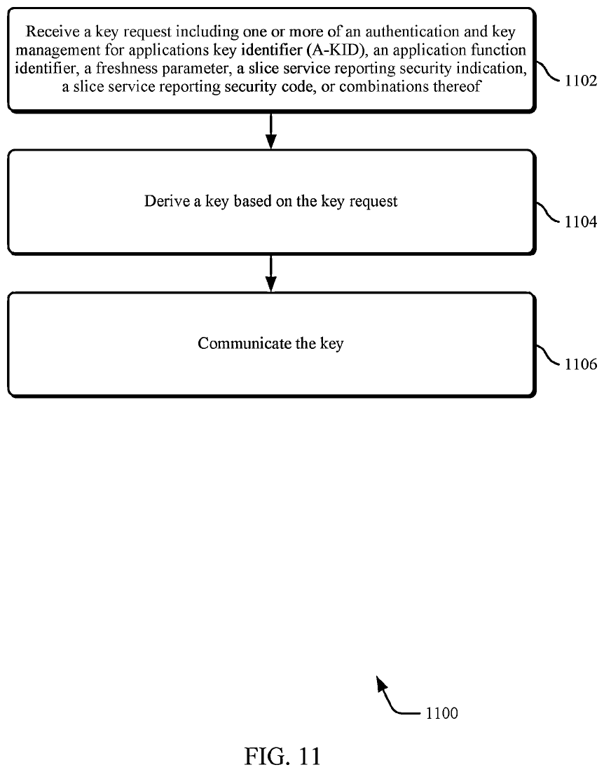

FIG. 11 illustrates a flowchart of a method 1100 that supports service management in wireless networks in accordance with aspects of the present disclosure. The operations of the method 1100 may be implemented and performed by a device or its components, such as a network device (e.g., a core network function) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1102, the method may include receiving a key request including one or more of an authentication and key management for applications key identifier (A-KID), an application function identifier, a freshness parameter, a slice service reporting security indication, a slice service reporting security code, or combinations thereof. The operations of 1102 may be performed in accordance with examples as described herein. In some implementations, aspects of the operations of 1102 may be performed by a device as described with reference to FIG. 1.

At 1104, the method may include deriving a key based on the key request. The operations of 1104 may be performed in accordance with examples as described herein. In some implementations, aspects of the operations of 1104 may be performed by a device as described with reference to FIG. 1.

At 1106, the method may include communicating the key. The operations of 1106 may be performed in accordance with examples as described herein. In some implementations, aspects of the operations of 1106 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (e.g., A and B and C). Similarly, a list of one or more of A, B, or C means A or B or C, or AB or AC or BC, or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
generate a first message indicating service rejection information associated with a service rejection;
generate a key to protect the first message;
generate a secured first message using the key and the first message;
transmit the secured first message; and
receive, based on the secured first message, slice serving network data comprising a preferred visited network list for slice services for the UE.

2. The UE of claim 1, wherein to generate the secured first message, the at least one processor is configured to cause the UE to use the key to generate a hashed message authentication code of the first message to generate at least a portion of the secured first message.

3. The UE of claim 1, wherein the at least one processor is further configured to cause the UE to receive a second message indicating the service rejection for a service associated with a network slice and UE subscription data, the first message including the service rejection information.

4. The UE of claim 1, wherein to generate the secured first message, the at least one processor is further configured to cause the UE to use the key, a second message containing slice rejection information comprising one or more of a reference identifier, sender information, a UE identifier, a network function identifier, a visited network identifier, subscribed slice identification information, subscribed service identification information, failure cause information, a timestamp, a key identifier, a freshness parameter, or a slice service reporting code.

5. The UE of claim 1, wherein the at least one processor is further configured to cause the UE to transmit a key identifier for the key with the secured first message.

6. The UE of claim 1, wherein the key comprises one or more of an authentication server function (AUSF) key, a slice service reporting key, or an authentication and key management for applications (AKMA) key, a key derived from an authentication server function (AUSF), a key derived from a slice service reporting key, a key derived from an authentication and key management for applications (AKMA) key, and input parameters.

7. The UE of claim 6, wherein the input parameters used for the key generation include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof.

8. The UE of claim 1, wherein the key comprises one or more of a slice reporting root key, an integrity key, a confidentiality key, or combinations thereof.

9. The UE of claim 1, wherein the preferred visited network list is prioritized based on one or more of visited network service capabilities or slice serving capabilities.

10. The UE of claim 9, wherein the preferred network list is protected by a medium access control (MAC) and based at least in part on a second key.

11. An apparatus for wireless communication, comprising:
at least one memory; and
at least one processor coupled with the at least one memory and configured to cause the apparatus to:
receive, at a visited network from a user equipment (UE), a service request for access to a service associated with a network slice;
reject, based on a condition, the service request;
generate a message that includes a UE identifier for the UE, an identifier for the service associated with the network slice, and service rejection information; and
transmit the message to a home network of the UE.

12. The apparatus of claim 11, wherein the at least one processor is configured to cause the apparatus to generate the message to include one or more of a service rejection code, a service rejection reason, an identifier for the visited network, a network function identifier, a time stamp, or a digital signature.

13. The apparatus of claim 11, wherein the at least one processor is configured to cause the apparatus to transmit the message to a function in the home network using one or more of a reporting address for reporting slice service information to the home network, or a fully qualified domain name (FQDN) associated with the home network.

14. The apparatus of claim 11, wherein the at least one processor is configured to cause the apparatus to receive, from the home network, an acknowledgement of the message.

15. The apparatus of claim 11, wherein the at least one processor is configured to cause the apparatus to:
receive, from the UE, a second message based on the rejected service request; and
transmit the second message to the home network of the UE.

16. An apparatus for wireless communication, comprising:
at least one memory; and
at least one processor coupled with the at least one memory and configured to cause the apparatus to:
receive a secured first message generated by a user equipment (UE), the secured first message including a UE identifier and indicating that the secured first message is associated with a service rejection; and
verify the secured first message using a key associated with one or more of the UE identifier or the service rejection.

17. The apparatus of claim 16, wherein the at least one processor is configured to cause the apparatus to:
receive a key identifier from the UE;
derive the key and a key identifier; and
validate the key using the key identifier.

18. The apparatus of claim 17, wherein input parameters used to derive the key include one or more of a UE identifier, a subscription permanent identifier (SUPI), a home network identifier, a freshness parameter, a nonce, a random number, a counter, a slice service reporting code, a slice service reporting keyword, a confidentiality code, an integrity code, or combinations thereof.

19. The apparatus of claim 17, wherein the key comprises one or more of a slice reporting root key, an integrity key, a confidentiality key, or combinations thereof.

20. (canceled)

21. A processor for wireless communication, comprising:
at least one controller coupled with at least one memory and configured to cause the processor to:
generate a first message indicating service rejection information associated with a service rejection;
generate a key to protect the first message;
generate a secured first message using the key and the first message;
transmit the secured first message; and
receive, based on the secured first message, slice serving network data comprising a preferred visited network list for slice services.
